(19) United States
(12) Patent Application Publication
(10) Pub. No.: US 2007/0040901 A1
(43) Pub. Date: Feb. 22, 2007

(54) VIDEO PROCESSING APPARATUS AND OBJECT PROCESSING METHOD

(76) Inventor: Taeko Yamazaki, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/462,768

(22) Filed: Aug. 7, 2006

(30) Foreign Application Priority Data
Aug. 22, 2005 (JP) 2005-240199 (PAT)

(51) Int. Cl. H04N 7/14

(52) U.S. Cl. 348/14.08

(57) ABSTRACT

Photographs a predetermined action performed to an object with an appliance by a photographing device, and records it as video data. When a desired object is specified while the video data is being played back, the object is identified based on information on a position of the object in the appliance and a time the object acted, and operation authority of a user against the identified object is determined. Predetermined operation is enabled to be executed against the predetermined object according to the result of the determination.

### BACKGROUND OF THE INVENTION

1. Field of the Invention

The present invention relates to a technique of photographing action performed to an object with an appliance by a photographing device, recording it as video data, and playing back the video data.

2. Description of the Related Art

There has been an increase in the need to film (video-capture) operation or conference contents which are performed in a working position, a conference room or the like by using appliances such as a display, a printer or the like, and to use the filmed (captured) video as a record of the operation or a record of the conference. In such a case, it has been needed to improve convenience in searching for a target object from a lengthy video and various techniques for that purpose have been proposed (for example, prior art references 1, 2).

Prior art reference 1 intends to extract a reusable graphic object from a usual white board. It extracts a drawn graphic object from capture data on a white board in a photographed video. Accordingly, the graphic object can be associated with audio data which works together on a time axis.

Prior art reference 2 intends to create minutes on time. It can create minutes from a conference management server by managing a time when presentation data is presented or a time when material data is presented, and associating the stored presentation data and material data with the times.

Prior art references 1, 2 are shown below.

Prior Art Reference 1: Japanese Patent Laid-Open No. 2004-080750

Prior Art Reference 2: Japanese Patent Laid-Open No. 2001-331614

In prior art reference 1, however, only a usual white board is targeted and a method for identifying an appliance and an object in the appliance is not focused on. Therefore, it can neither identify a display object on a display nor a print object on a printer output tray.

Almost all of the objects appearing in minutes are confidential information and security needs to be considered to disclose the presentation data. As the prior art reference 2 does not mention actions in playing back generated minutes, it cannot limit viewing or operation of the minutes.

### SUMMARY OF THE INVENTION

The present invention is adapted to solve the above-mentioned problems and intends to enable an appliance and an object in the appliance that is identified in a playback video such as a display object on a display to be subject to enlarged display or print.

It also intends to enable operation of presenting or printing a highly readable master copy of an object, and also improve confidentiality by giving operation authority to the object.

In order to achieve the abovementioned object, according to an aspect of the present invention, a video processing apparatus for photographing an action performed to an object with an appliance by a photographing device, recording it as video data, and playing back the video data, comprising: identifying means for identifying the object specified; determining means for determining operation authority of a user against the identified object; and operating means for enabling predetermined operation to be executed against the identified object according to the result of the determination, is provided.

According to an aspect of the present invention, an object processing method of a video processing apparatus which photographs an action performed to an object with an appliance by a photographing device, recording it as video data, and playing back the video data, comprising: an identifying step of identifying the object specified; a determining step of determining operation authority of a user against the identified object; and an operating step of enabling predetermined operation to be executed against the identified object according to the result of the determination, is provided.

Further features of the present invention will become apparent from the following description of exemplary embodiments (with reference to the attached drawings).

### BRIEF DESCRIPTION OF THE DRAWINGS

FIG. 1 is a block diagram showing a hardware configuration of information processing apparatus in an embodiment;

FIG. 2 is a diagram showing an example of a system image in the first embodiment;

FIG. 3 is a system block diagram showing a configuration for realizing a system image shown in FIG. 2;

FIGS. 4A and 4B are functional block diagrams showing functions of the conference recording device 305 and the conference record playback device 309 shown in FIG. 3;

FIG. 5 is a flowchart showing conference record processing in the first embodiment;

FIG. 6 is a diagram showing an example of object action record data 306;

FIG. 7 is a flowchart showing object action record processing in the first embodiment;

FIG. 8 is a diagram showing an example of object authority data;

FIG. 9 is a flowchart showing conference record playback processing in the first embodiment;

FIGS. 10A and 10B are diagrams showing examples of a conference video operating screen in which playback operation of a conference video and operation of an object displayed at a specified position in a playback video can be performed;

FIG. 11 is a flowchart showing conference video operation processing in the first embodiment;

FIG. 12 is a diagram showing an example of appliance position shape data 308;

FIG. 13 is a flowchart showing appliance position shape obtain processing for obtaining appliance position shape data at a time corresponding to the playback position in the first embodiment;

FIG. 14 is a flowchart showing specified appliance identify processing in the first embodiment;

FIG. 15 is a flowchart showing object in specified appliance identify processing in the first embodiment;

FIG. 16 is a flowchart showing object position shape obtain processing shown in FIG. 15;

FIG. 17 is a flowchart showing relative position in a display identify processing shown in FIG. 15;

FIG. 18 is a flowchart showing object action search processing in the first embodiment;

FIG. 19 is a flowchart showing object operation processing in the first embodiment;

FIG. 20 is a flowchart showing object authority obtain processing in the first embodiment;

FIG. 21 is a flowchart showing object operation item select processing in the first embodiment;

FIG. 22 is a flowchart showing object master copy obtain processing in the first embodiment;

FIG. 23 is a diagram showing an example of an enlarged display presenting screen;

FIG. 24 is a diagram showing an example of a master copy display presenting screen;

FIG. 25 is a diagram showing an example of a template when object authority is automatically set in the second embodiment;

FIG. 26 is a diagram showing an example of object authority data;

FIG. 27 is a diagram showing an example of a template when object authority is automatically set in the third embodiment;

FIG. 28 is a diagram showing an example of a conference video operating screen on which playback operation of a conference video and designation of authority of an object which is displayed on a specified position in the playback video can be executed in the fourth embodiment;

FIG. 29 is a diagram showing an example of an object authority detail setting screen in which object authority of an object is explicitly set;

FIG. 30 is a diagram showing an example of a user adding screen in object authority detail setting in which object authority of an object can be explicitly set;

FIG. 31 is a flowchart showing object authority setting designation processing in the fourth embodiment; and

FIG. 32 is a flowchart showing object authority setting user add processing in the fourth embodiment.

### DESCRIPTION OF THE EMBODIMENTS

The preferred embodiments for implementing the present invention will be described in detail with reference to the drawings.

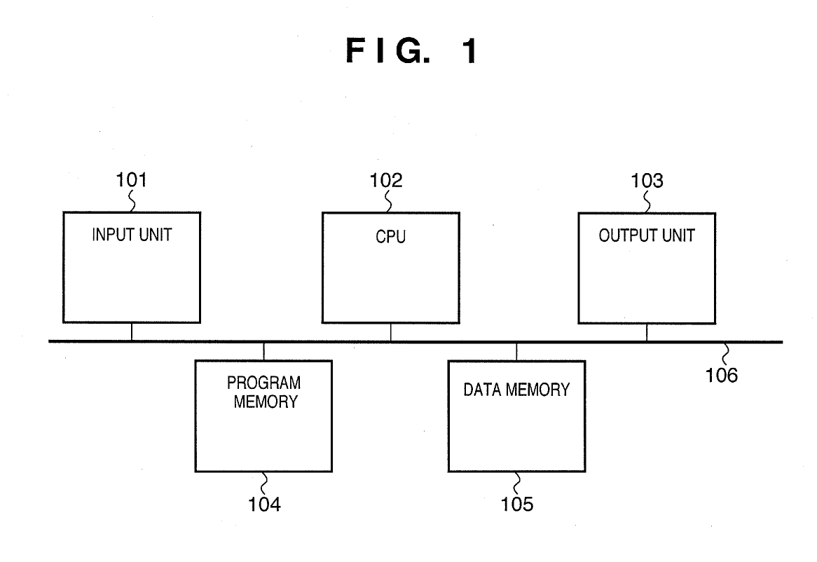

FIG. 1 is a block diagram showing a hardware configuration of information processing apparatus in an embodiment. In FIG. 1, the reference numeral 101 denotes an input unit for inputting information (data), and is connected to a photographing device or the like to be described later. The reference numeral 102 denotes a CPU, which performs calculation, logical determination or the like for various types of processing, and controls each component connected to a bus to be described later. The reference numeral 103 denotes an output unit for outputting information (data), and is connected to a video forming device including a display such as an LCD, a CRT or the like, a printer or the like to be described later, for example.

The reference numeral 104 denotes program memory, which is memory for storing a program which includes a processing procedure shown by the flowchart to be described later and which is for controlled by a CPU 102. The program memory 104 may be ROM, or may be RAM to which a program is loaded from an external storage device or the like. The reference numeral 105 denotes data memory and stores data generated in various types of processing. The data memory 105 is assumed to be RAM, for example, and it is loaded prior to processing from a non-volatile external storage medium, or referenced each time it is needed.

Then, the reference numeral 106 denotes a bus for transferring address signals for designating respective components to be controlled by the CPU 102, control signals for controlling respective components, and data which is exchanged among respective components.

### First Embodiment

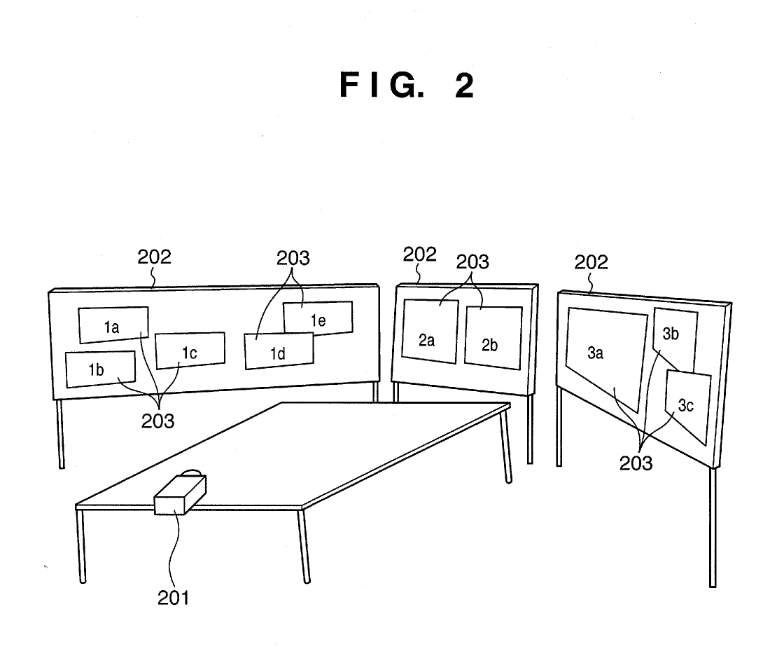

Here, by using FIG. 2 to FIG. 24, a case where an appliance and an object in the appliance corresponding to a position in a time and a position in a space designated in the playback video are identified and operation such as enlarged display, printing or the like is executed based on access authority of an object will be described. In the term “an appliance”, a home appliance and an office appliance are included (hereinafter simply referred to as an appliance). In a first embodiment, a case where particularly a target appliance is a display and an actual shape of a display (aspect ratio or the like) is not kept because of distortion due to the position of a camera or characteristics of a lens will be described.

FIG. 2 is a diagram showing an example of a system image in the first embodiment. The system shown in FIG. 2 visualizes a conference room, including three displays 202 with large screens, and a conference video photographing camera (hereinafter simply referred to as a camera) 201 which photographs a conference with an wide angle as well as a conference desk in a usual conference room. It is also shown that a plurality of display objects 203 are displayed on each screen on the displays 202.

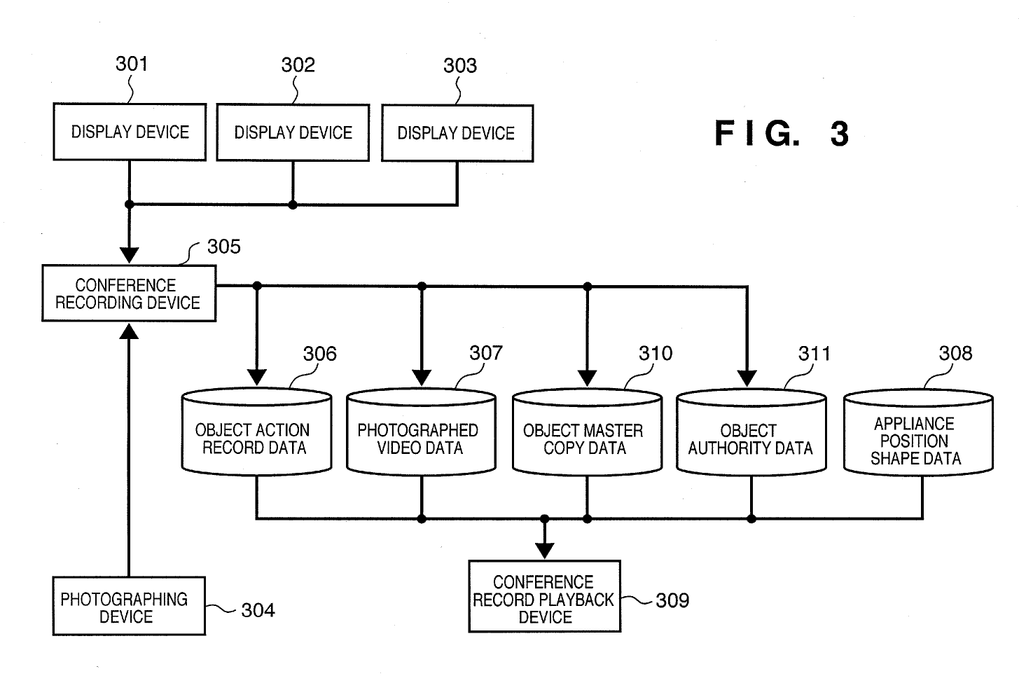

FIG. 3 is a system block diagram showing a configuration for realizing a system image shown in FIG. 2. As shown in FIG. 3, information on each display object displayed on display devices 301 to 303 is recorded as the object action record data 306 by a conference recording device 305. Like information on each display object, a video photographed by a photographing device 304 is also recorded as photographed video data 307.

The object action record data 306 and the photographed video data 307 recorded in such a manner are played back by a conference record playback device 309 by referencing data below.
Appliance position shape data 308 which records a position or a shape of each appliance in a photographed video
Object master copy data 310 corresponding to a master copy of a displayed object
Object authority data 311 which records operation authority such as viewing of an object

In the first embodiment, the information processing apparatus shown in FIG. 1 functions as the conference recording device 305 and the conference record playback device 309 shown in FIG. 3. Specifically, it has a function of performing an appliance position shape automatic setting or appliance position shape designation to be described later.

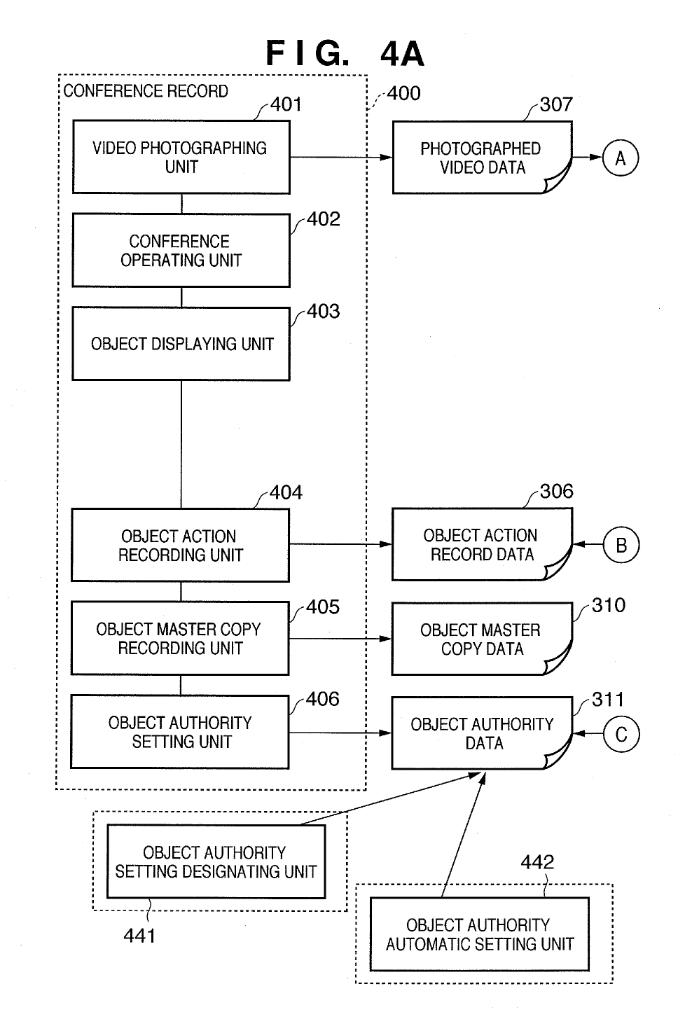

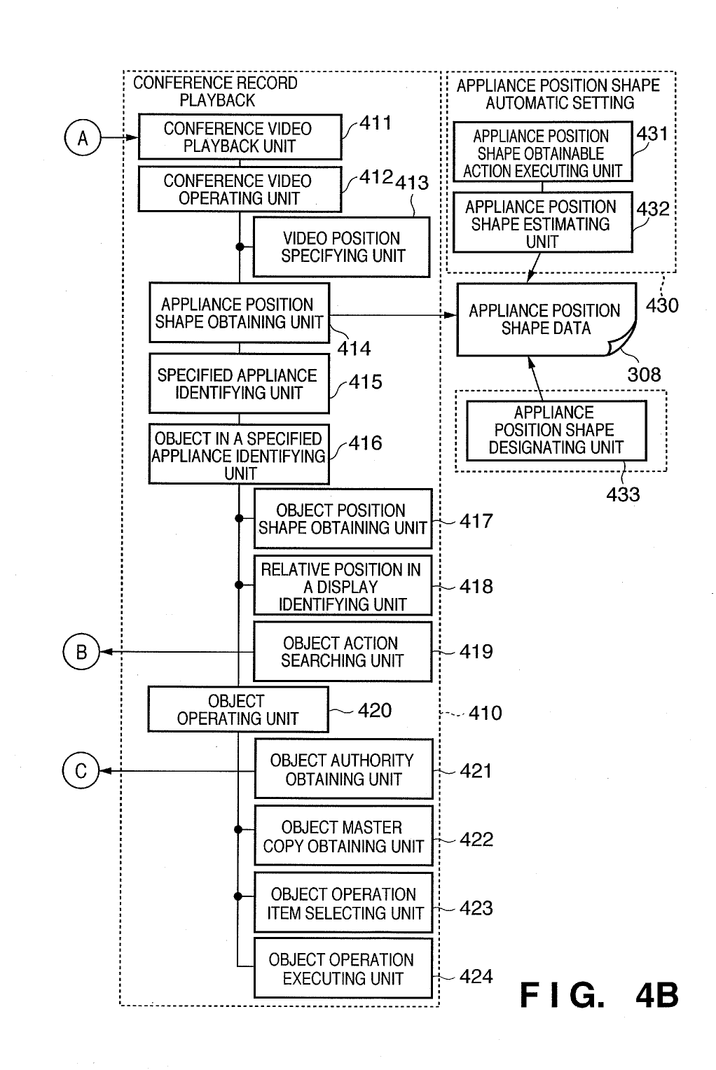

FIGS. 4A and 4B are functional block diagrams showing functions of the conference recording device 305 and the conference record playback device 309 shown in FIG. 3. As shown in FIGS. 4A and 4B, it consists of respective functions of conference record 400 (corresponding to the conference recording device 305), conference record playback 410 (corresponding to the conference record playback device 309), and appliance position shape automatic setting 430. The conference record 400 provides a function of recording conference contents. The conference record playback 410 provides a function of playing back a recorded conference record. The appliance position shape automatic setting 430 provides a function of estimating an appliance position shape by causing an appliance to execute an action which involves change in a video. It also has an appliance position shape designating unit 433 that designates an appliance position shape necessary to identify an object in an appliance in a playback video.

The conference record 400 consists of a video photographing unit 401, a conference operating unit 402, an object displaying unit 403, an object action recording unit 404, an object master copy recording unit 405, and an object authority setting unit 406. The video photographing unit 401 records a conference photographed by the photographing device 304 as photographed video data 307. The conference operating unit 402 performs designation to display or designation to write into an electric white board of conference materials. The object displaying unit 403 displays a display object according to the designation.

The object action recording unit 404 records an action performed on a display object as object action record data 306. The object master copy recording unit 405 records electric data, such as a still image or a presentation file which corresponds to a master copy of a display object, to the object master copy data 310. The object authority setting unit 406 sets authority of operation such as enlargement, printing, and presenting of a master copy or the like of an object.

Next, the configuration of a conference record playback 410 will be described. It will be further detailed later. A conference video playback unit 411 plays back a conference video recorded as the abovementioned photographed video data 307. A conference video operating unit 412 operates a video being play. A video position specifying unit 413 specifies any position in a video. An appliance position shape obtaining unit 414 obtains an appliance position shape by using predefined appliance position shape data 308. A specified appliance identifying unit 415 identifies an appliance at a specified position. An object in a specified appliance identifying unit 416 identifies an object in an appliance at a specified position. An object position shape obtaining unit 417 obtains a position shape of a specified object. A relative position in a display identifying unit 418 identifies a relative position in a display corresponding to a specified position. An object action searching unit 419 searches an object action corresponding to a specified position. An object operation unit 420 operates an identified object.

An object authority obtaining unit 421 obtains operation authority of an object from the object authority data 311. An object master copy obtaining unit 422 obtains an object master copy from an identified object. An object operation item selecting unit 423 selects operating item which can be executed on an object. An object operation executing unit 424 executes object operation.

Appliance position shape automatic setting 430 consists of an appliance position shape obtainable action executing unit 431 for causing an appliance to execute an action involving change in a video, and an appliance position shape estimating unit 432 for automatically setting definition of the appliance position shape data 308 by analyzing change in a video and estimating an appliance position shape. An appliance position shape designating unit 433 designates definition of the appliance position shape data 308.

An object authority setting designating unit 441 designates definition of the abovementioned object authority data 311. Then, an object authority automatic setting unit 442 automatically sets definition of the abovementioned object authority data 311 according to a previously created template.

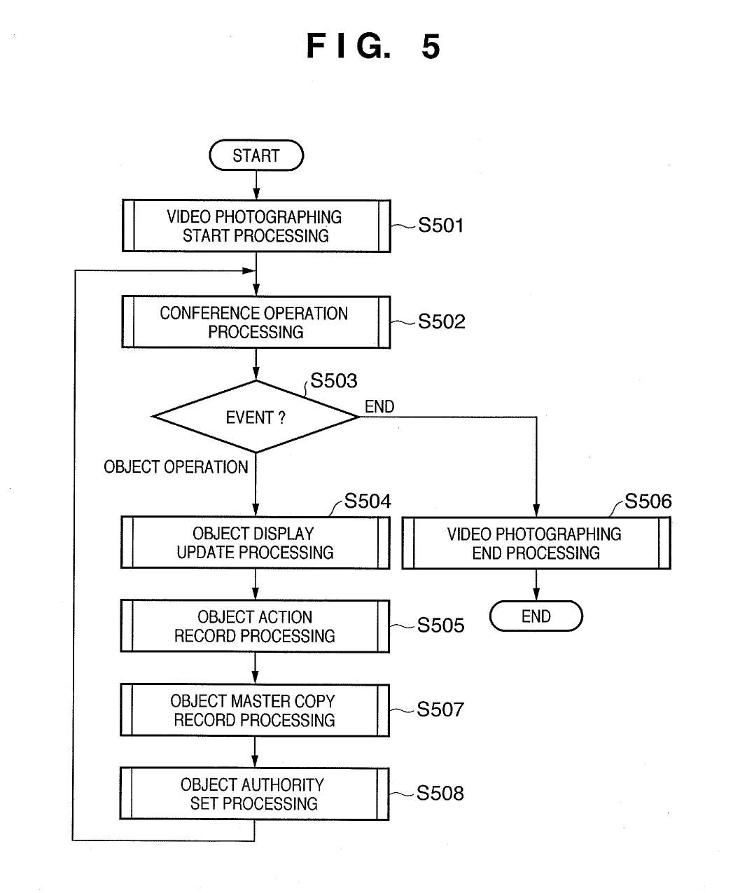

FIG. 5 is a flowchart showing conference record processing in the first embodiment. When the conference record 400 is designated to start photographing, recording of the photographed video data 307 starts at the step S501 (video photographing start processing). Then at the step S502, it receives user's operation (conference operation processing), and if it is determined as object operation designation at the next step S503, the operation proceeds to the step S504, and a corresponding object is updated in display (object display update processing) Then at the step S505, the display updating action is recorded as object action record data 306 (object action record processing).

Next at the step S507, electric data, such as a still image or a presentation file which corresponds to a master copy of an object, is recorded (object master copy record processing). Then at the step S508, authority of operation such as enlargement, printing, and presentation of a master copy of an object is set (object authority set processing), and the operation returns to the step S502, and the abovementioned processing is repeated. If it is determined as designation to end at the step S503, the operation proceeds to the step S506, and the photographing ends (video photographing end processing), and the conference record processing ends.

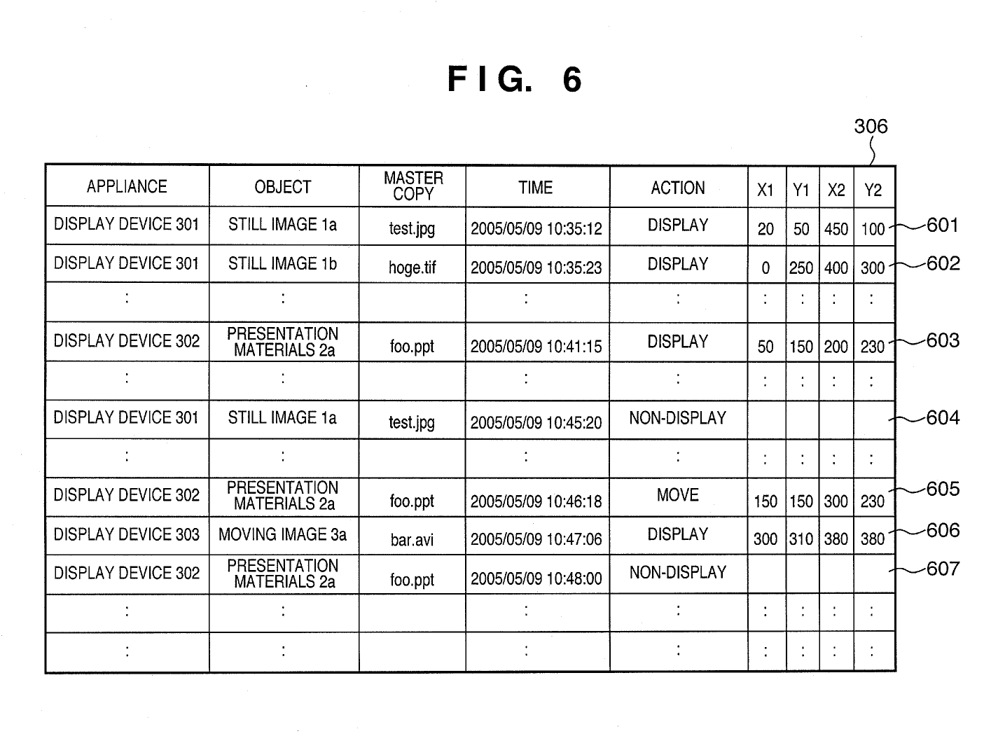

FIG. 6 is a diagram showing an example of object action record data 306. As those denoted by the reference numerals 601 to 607 in FIG. 6, in the object action record data 306, information for identifying an appliance, an object in an appliance, a time an object acted, a type of action, display regions (X1, Y1, X2, Y2) is recorded. Information for identifying a master copy of an object is also recorded.

For example, that a still image 1a of a master copy name “test.jpg” is displayed in a display region ((20, 50), (450, 100)) on the display device 301 at a time (2005/05/09 10:35:12) is recorded as object action record data 601. Then, that the object (still image 1a) is made non-displayed is recorded as object action record data 604.

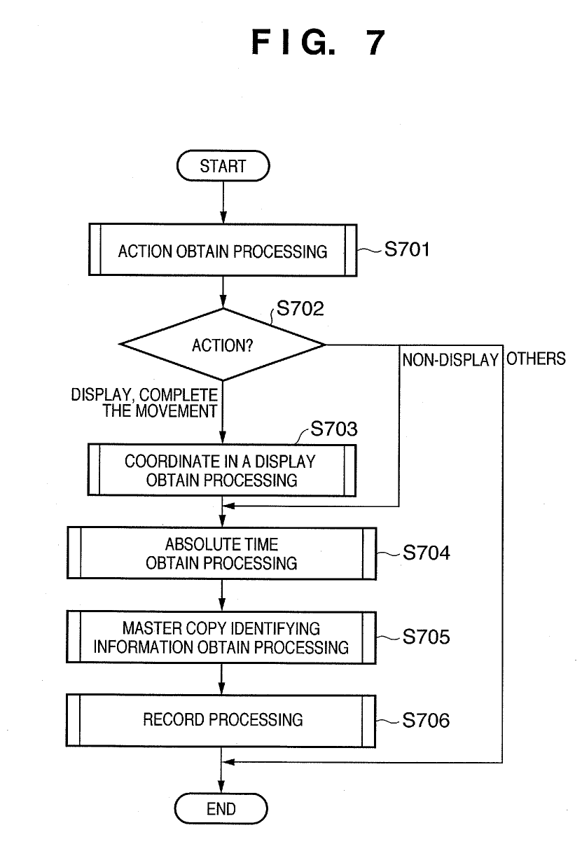

FIG. 7 is a flowchart showing object action record processing in the first embodiment. First at the step S701, an action type of an object is obtained from the object action record data 306 (action obtain processing). Then at the step S702, an action type is determined, and if the action type is “display” or “complete the movement”, the operation proceeds to the step S703, and a display region of the object in the display is obtained (coordinate in a display obtain processing).

If the action type is “non-display” at the step S702, the operation proceeds to the step S704, and an absolute time of the system is obtained from an operation time on each display device (absolute time obtain processing). Next at the step S705, information for identifying a master copy of an object, for example, a master copy file name is obtained (master copy identifying information obtain processing). Then at the step S706, the information obtained by the abovementioned processing is recorded as the object action record data 306 (record processing), and the processing ends. On the other hand, if the action type is other than those mentioned above at the step S702, the processing after the step S702 is not executed and the processing ends.

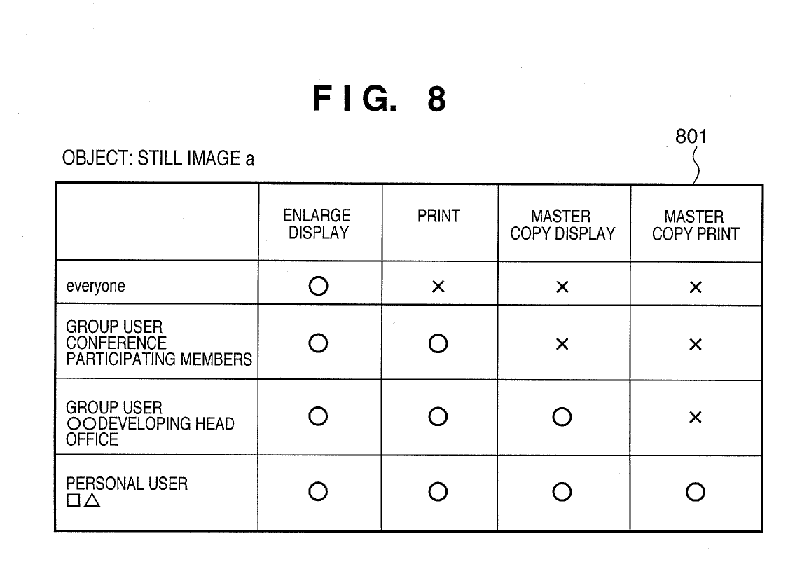

FIG. 8 is a diagram showing an example of object authority data. The object authority data is that records data, in which executable functions on an object is set for each user. In the object authority data, object authority data 801, for example, shows a function which can be implemented on the still image 1a of an object. A personal user “[ ]A” is permitted to enlarge display, print an object in a video image, present electric data which is a master copy of an object, and print an object master copy.

Similar for another user, if it is a group user “◯◯ developing head office”, enlarged display, printing of an object in a video image, and presenting of an object master copy are permitted. If it is a group user “conference participating members”, enlarged display and printing of an object in a video image are permitted. For the other users “everyone”, only enlarged display of an object in a video image is permitted. The object authority data is present for each object in a video and saved as an object authority data list.

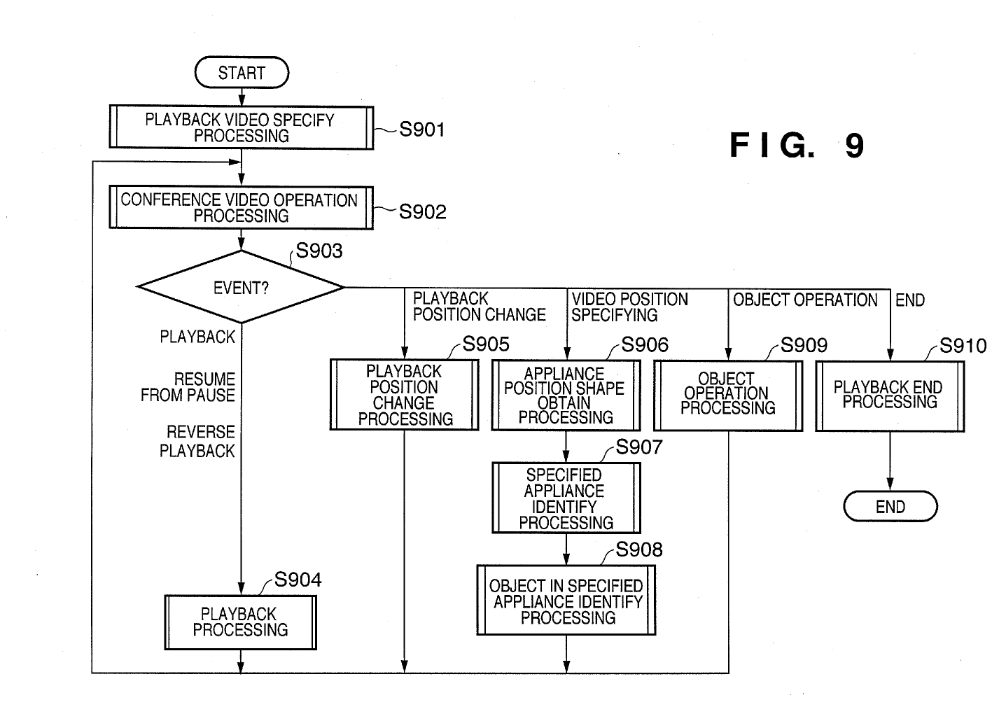

FIG. 9 is a flowchart showing conference record playback processing in the first embodiment. First, when a conference record to be operated is designated for the conference record playback 410 at the step S901 (playback image designate processing), the operation is waited to be executed at the following step S902 (conference video operation processing). If the operation is executed and the operation is any of “playback”, “resume from a pause”, “reverse playback” at the step S903, the operation proceeds to the step S904. At the step S904, playback or reverse playback is executed from a specified position (playback processing), and the operation proceeds to the step S902 and the abovementioned processing is repeated.

If the operation is “change playback position” designation at the step S903, the operation proceeds to the step S905 and the playback position is changed to the specified position (playback position change processing), and the operation proceeds to the step S902 and the abovementioned processing is repeated.

If the operation is “video position specifying” designation at the step S903, the operation proceeds to the step S906, and appliance position shape data at a time corresponding to the playback position is obtained (appliance position shape obtain processing). Then at the step S907, an appliance corresponding to the specified position is identified (specified appliance identify processing). Next at the step S908, an object in an appliance corresponding to the specified position is identified as the object action record data 306 is referenced (object in a specified appliance identify processing). Then the operation returns to the step S902, and the abovementioned processing is repeated.

If the operation is “object operation” designation at the step S903, the operation proceeds to the step S909, and specified operation for an object identified in the abovementioned procedure is executed (object operation processing). Then the operation returns to the step S902, and the abovementioned processing is repeated. If the operation is “end” at the step S903, the operation proceeds to the step S910, the playback ends (playback end processing) and the processing ends.

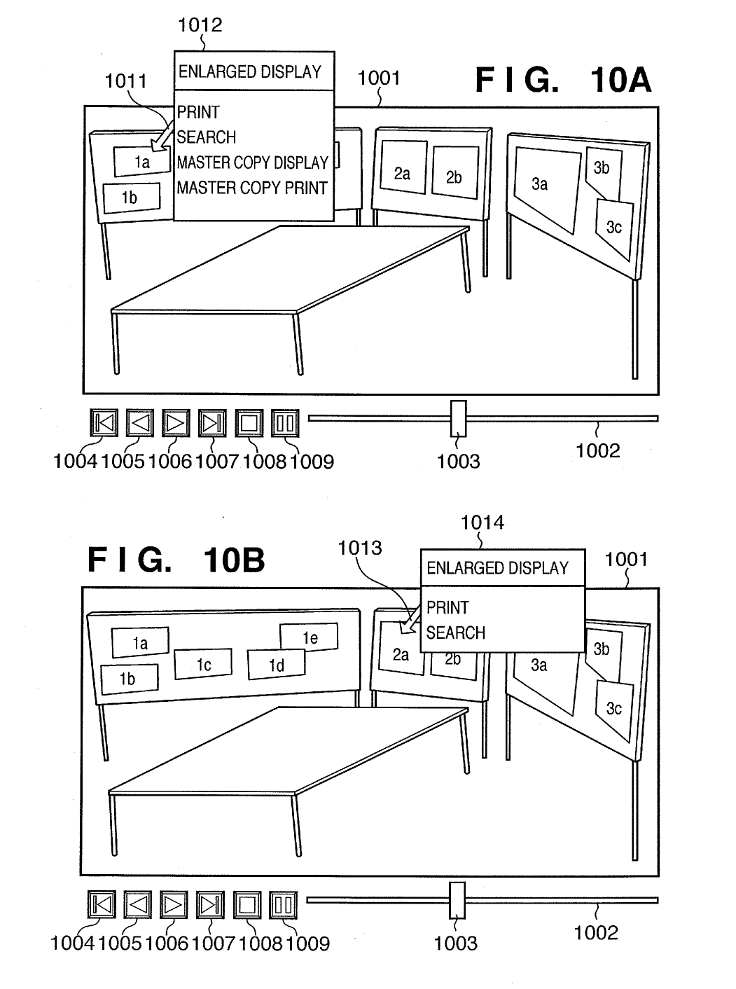

FIGS. 10A and 10B are diagrams showing examples of a conference video operating screen in which playback operation of a conference video and operation of an object displayed at a specified position in a playback video can be performed. In the example, a playback position is indicated as a position 1003 on a scroll bar 1002 and a video 1001 at a corresponding time is displayed. Designation buttons including move to the top 1004, reverse playback 1005, playback 1006, move to the end 1007, stop 1008, and pause 1009 on the playback video are shown.

On the other hand, operation on an object in the playback video is executed as an arbitrary position in the playback video 1001 is specified 1011 at first, and object operation menu 1012 corresponding to the specified position is displayed. Operation displayed in the object operation menu 1012 is presented based on object authority data. As object authority data is present for each object, a different menu is displayed for each specified object or for each operating user. For example, as the specified objects (1011, 1013) are different between FIG. 10A and FIG. 10B, types of operation presented in the operation menus (1012, 1014) are also different.

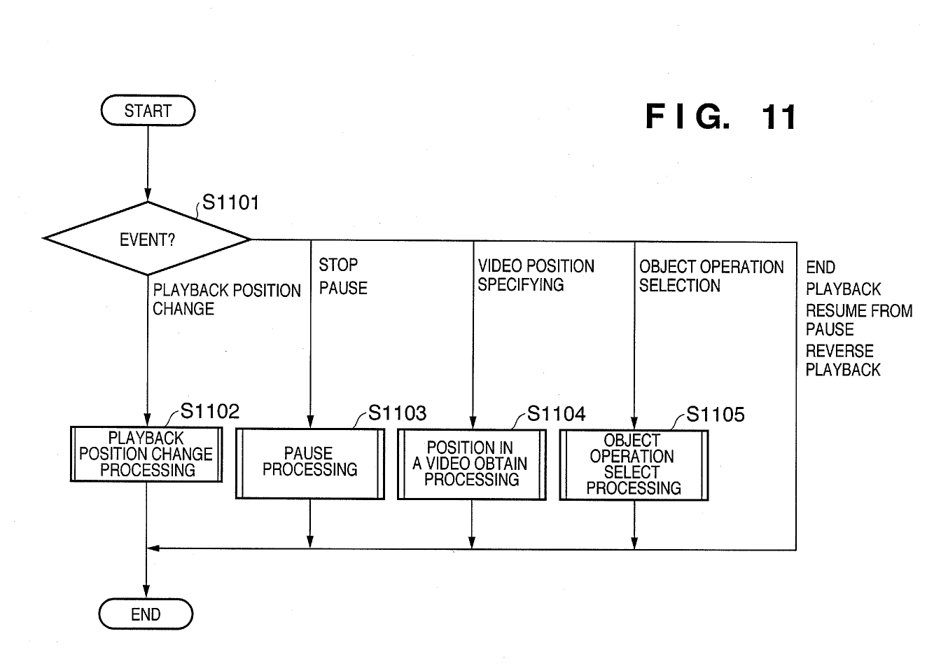

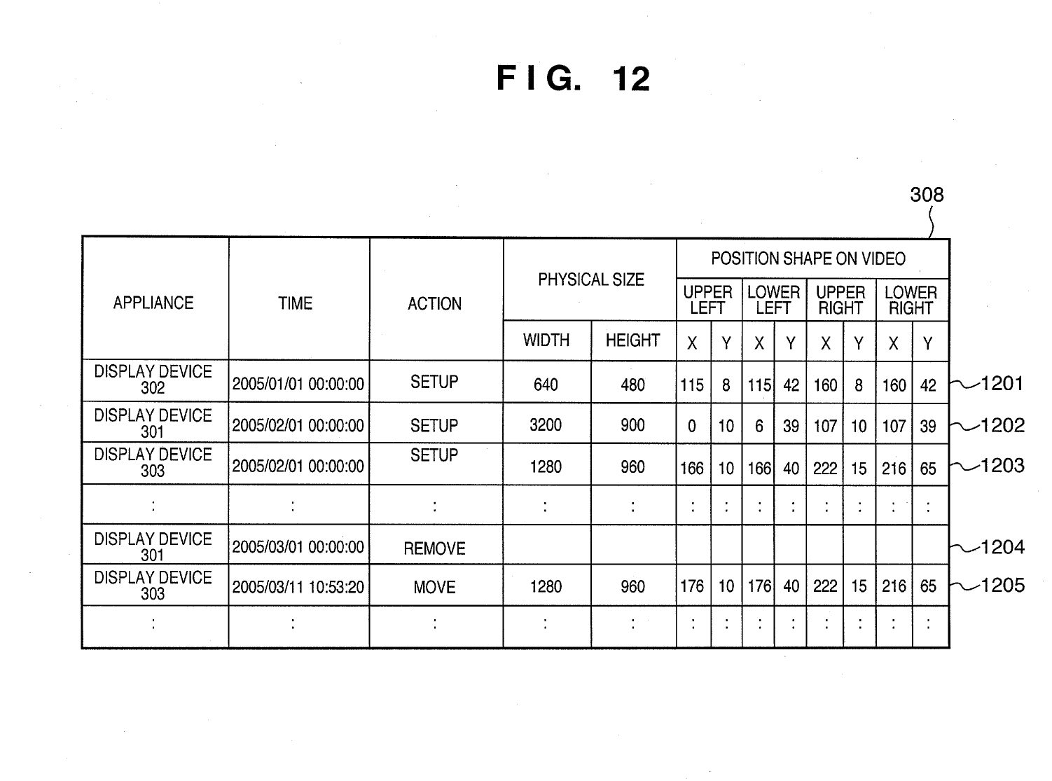

FIG. 11 is a flowchart showing conference video operation processing in the first embodiment. First at the step S1101, executed operation is determined. As a result, if the executed operation is designation involving “playback position change” including change of the position 1003, move to the top 1004 and move to the end 1007 or the like on the scroll bar 1002, the operation proceeds to the step S1102 and the playback position is changed (playback position change processing), and the processing ends.

If the operation executed at the step S1101 is a designation involving “stop” and “pause” such as the stop 1008 and the pause 1009, the operation proceeds to the step S1103 and the playback stops (pause processing) and the processing ends. If the operation executed at the step S1101 is “video position specification” operation by specification 1011 or the like of any position in a playback video 1001, the operation proceeds to the step S1104 and the specified position information is obtained (position in video obtain processing) and the processing ends.

If the operation executed at the step S1101 is “object operation selection” designation, the operation proceeds to the step S1105 and the specifying operation is selected (object operation select processing) and the processing ends. Further, if it is operation other than those mentioned above at the step S1101, the abovementioned processing is not executed and the processing ends.

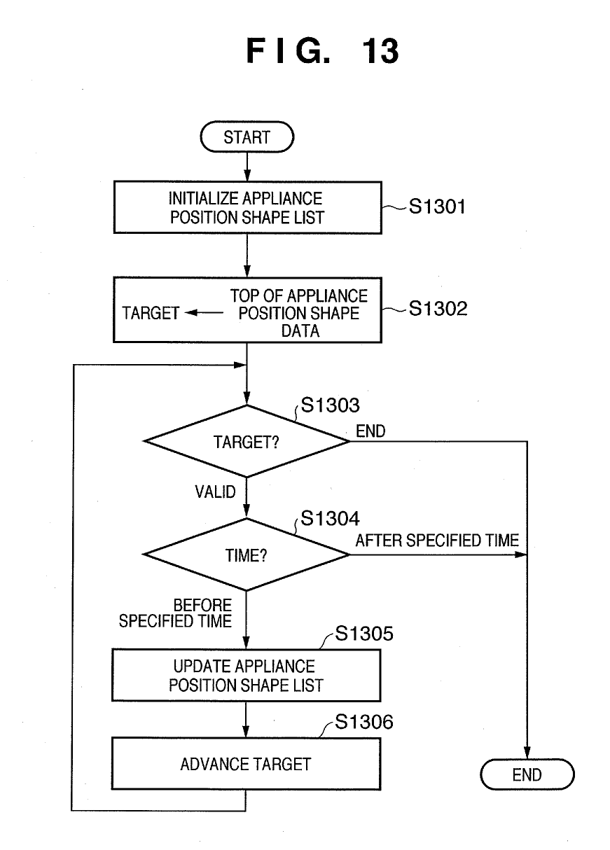

FIG. 12 is a diagram showing an example of appliance position shape data 308. As those denoted by the reference numerals 1201 to 1205 shown in FIG. 12, in the appliance position shape data 308, information for identifying an appliance, an acting time to the appliance, a type of action, a physical size indicating the actual size of an appliance, a position shape on a video (upper left, lower left, upper right, lower right) is recorded.

For example, those shown below are recorded as appliance position shape data 1201.

A display device 302 with a physical size (640, 480) and a position shape ((115, 8), (115, 42), (160, 8), (160, 42)) on a video is set up at the time (2005/01/01 00:00:00).

Further, that the display device 301 is removed is recorded as appliance position shape data 1204.

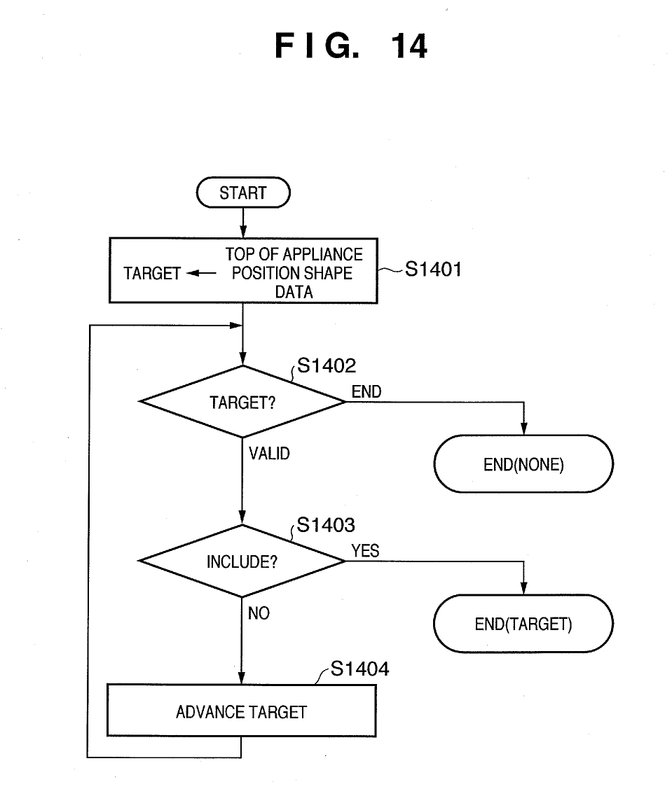

FIG. 13 is a flowchart showing appliance position shape obtain processing for obtaining appliance position shape data at a time corresponding to the playback position in the first embodiment. First, a list of appliance position shapes is initialized at the step S1301, and a target is initialized to the top of appliance position shape data at the following step S1302. Then at the step S1303, whether the target is valid or not is determined, and if it is valid, the operation proceeds to the step S1304 and whether the time indicated by appliance position shape data 308 of the target is before the time corresponding to the specified playback position or not is determined. As a result, if it is determined as before the specified time, the operation proceeds to the step S1305 and the list of appliance position shapes is updated. The target is advanced at the step S1306, then the operation returns to the step S1303 and the abovementioned processing is repeated.

On the other hand, if the target is not valid, i.e., if it is end at the step S1303, or if it is determined that the time indicated by the appliance position shape data of the target is after the time corresponding to the specified playback position at the step S1304, the processing ends.

FIG. 14 is a flowchart showing specified appliance identify processing in the first embodiment. First at the step S1401, the target is initialized to the top of the abovementioned appliance position shape data, and the processing after the step S1401 is repeated. Whether the target is valid or not is determined at the step S1402, and if it is valid, the operation proceeds to the step S1403 and whether a specified position is included in a display region shown by the position shape on a video in the appliance position shape data 308 of the target or not is determined. As a result, if the specified position is included in the display region, the processing ends with the appliance position shape data of the target being a returned value.

If the specified position is not included in the display region at the step S1403, the operation proceeds to the step S1404 and the target is advanced, and the operation returns to the step S1402 and the abovementioned processing is repeated. On the other hand, if the target is not valid, i.e., if no appliance corresponding to the specified position is present at the step S1402, the processing ends.

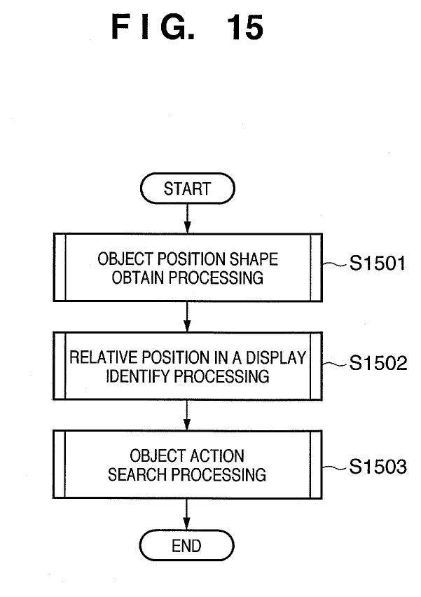

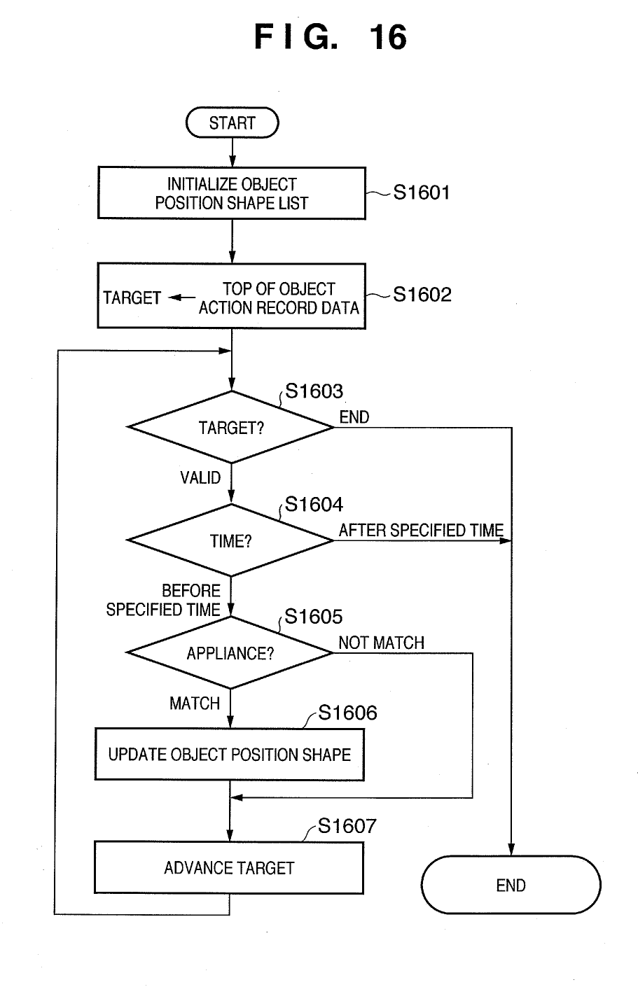

FIG. 15 is a flowchart showing object in specified appliance identify processing in the first embodiment. First at the step S1501, appliance position shape data at a time corresponding to a playback position is obtained (object position shape obtain processing). Next at the step S1502, a relative position in a display device in consideration of distortion on a video of a specified appliance is obtained (relative position in display identify processing). Then at the step S1503, object action record data corresponding to the specified position is searched for (object action search processing) and the processing ends.

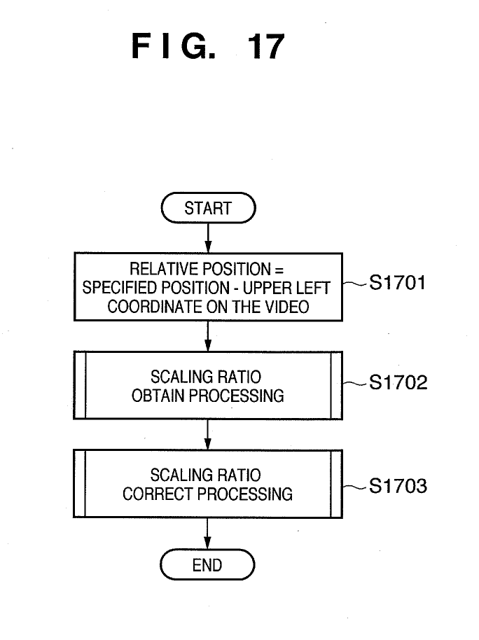

FIG. 16 is a flowchart showing object position shape obtain processing shown in FIG. 15. First at the step S1601, a list of object position shapes to be a returned value is initialized, and at the following step S1602, the target is initialized with the top of the object action record data. Then, the processing after the step S1602 is repeated.

If the target is valid at the step S1603, the operation proceeds to the step S1604 and, whether a time indicated by the object action record data of the target is before the specified time or not is determined. If it is determined as before the specified time, the operation proceeds to the step S1605, and whether it matches with the specified appliance or not is determined. As a result, if it is determined that it matches with the specified appliance, the operation proceeds to the step S1606 and the object position shape data in the list of object position shapes is updated. Then after the target is advanced at the step S1607, the operation returns to the step S1603 and the abovementioned processing is repeated.

On the other hand, if it is determined that the target ends at the step S1603, or if the time indicated by the object action record data of the target is determined as after the specified time at the step S1604, the list of object position shapes set till then is made returned values and the processing ends.

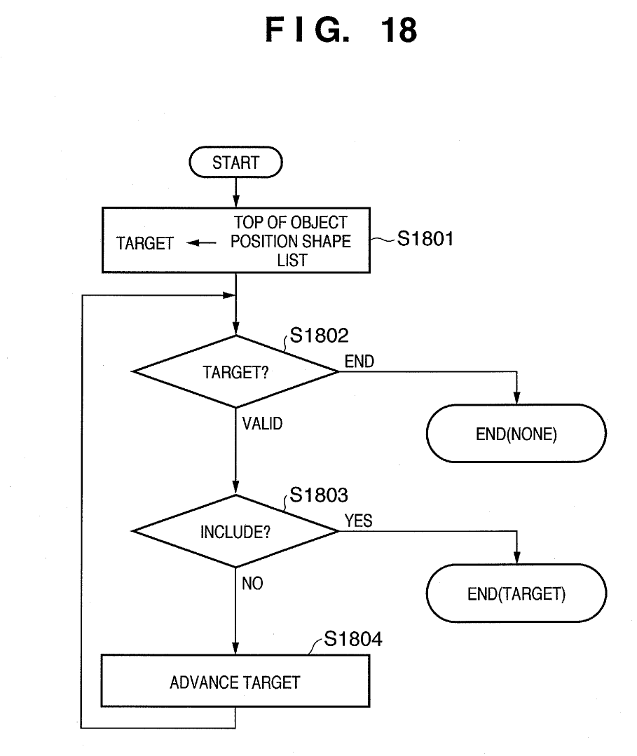

FIG. 17 is a flowchart showing relative position in a display identify processing shown in FIG. 15. First at the step S1701, a relative position is set as the upper left coordinate of a specified appliance on the video being a starting point, and at the following step S1702, a scaling ratio of the specified appliance on the video is obtained (scaling ratio obtain processing). Then at the step S1703, a relative position in a display device against the specified position is corrected by using the scaling ratio and the processing ends.

FIG. 18 is a flowchart showing object action search processing in the first embodiment. First at the step S1801, the target is initialized with the top of the list of object position shapes, and the processing at the following step S1802 and after that step is repeated.

Whether the target is valid or not is determined at the step S1802, and if it is valid, the operation proceeds to the step S1803, and whether the relative position in a display device indicated by the specified position is included in the display region of the object position shape data of the target or not is determined. As a result, if it is included in the display region, the processing ends with the object action record data of the target being a returned value.

If it is not included in the display region at the step S1803, the operation proceeds to the step S1804 and the target is advanced, and the operation returns to the step S1802 and the abovementioned processing ends. On the other hand, if the target is not valid at the step S1802, it is considered that the searching fails and the processing ends.

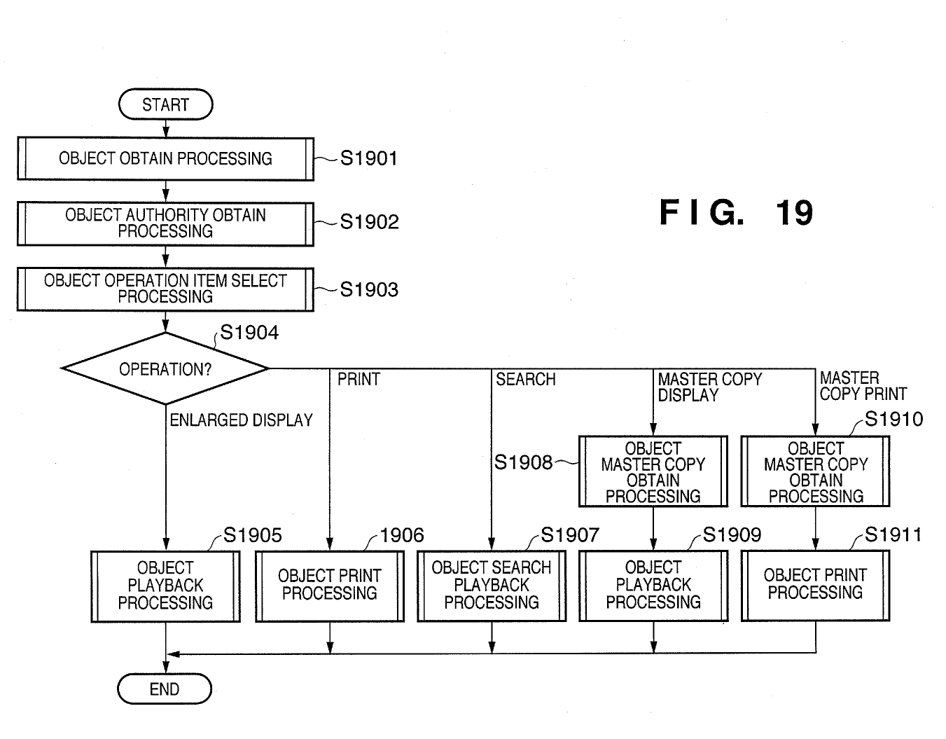

FIG. 19 is a flowchart showing object operation processing in the first embodiment. First at the step S1901, an object corresponding to the specified position identified by the abovementioned processing is obtained (object obtain processing). Authority of the obtained object is obtained at the step S1902, and an operation item of an object which is permitted to be executed is selected based on object authority and information on a user operating at the step S1903. Here, enlarged display, printing, searching, master copy display and master copy printing branch as operation items permitted to the user at the step S1904.

If specified operation is display designation at the step S1904, the operation proceeds to the step S1905, and playback processing of the identified object is executed (object playback processing) and the processing ends. If specified operation is printing designation at the step S1904, the operation proceeds to the step S1906, and print processing of the identified object is executed (object print processing) and the processing ends. If the specified operation is searching designation at the step S1904, the operation proceeds to the step S1907 and timing for the identified object to change is searched for, the video from the position is played back (object search playback processing) and the processing ends.

If the specified operation is a master copy display designation at the step S1904, the operation proceeds to the step S1908, a master copy of the object is obtained (object master copy obtain processing). Then at the step S1909, the master copy of the object is played back (object playback processing) and the processing ends. If the specified operation is master copy printing designation at the step S1904, the operation proceeds to the step S1910, and the master copy of the object is obtained (object master copy obtain processing). Then at the step S1911, print processing of the master copy of the object is executed (object print processing) and the processing ends.

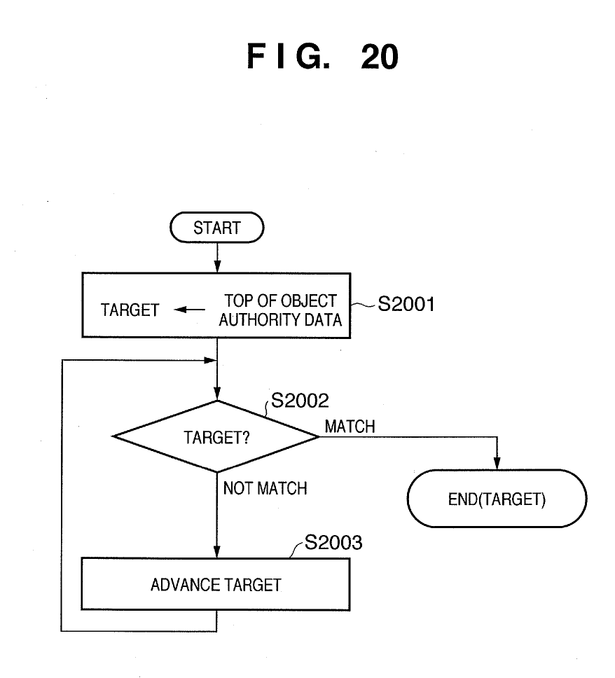

FIG. 20 is a flowchart showing object authority obtain processing in the first embodiment. First at the step S2001, the target is initialized to the top of the object authority data list, and the processing after the step S2001 is repeated. If the object authority data of the target does not match with the identified object at the step S2002, the operation proceeds to the step S2003 and the target is advanced, and then the operation returns to the step S2002 and the processing is repeated. If the object authority data of the target matches with the identified object at the step S2002, the object authority data of the target is returned as a returned value.

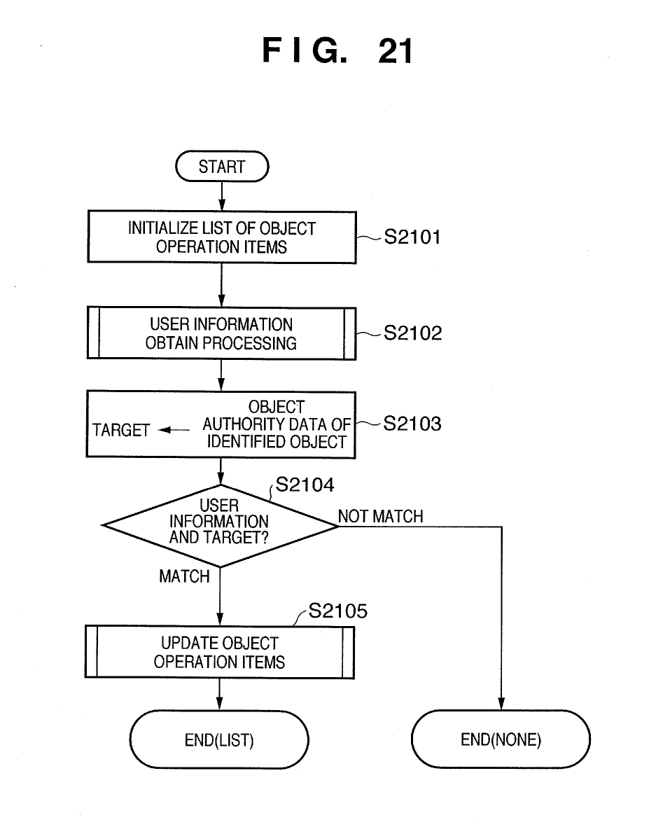

FIG. 21 is a flowchart showing object operation item select processing in the first embodiment. First, a list of object operation items is initialized at the step S2101, and information on an operating user is obtained at the step S2102. Then at the step S2103, the target is object authority data of the identified object obtained in the abovementioned processing. Next, if the target does not match with the user information at the step S2104, it is considered that selection from a list of object operation items is failed and the processing ends.

If the target matches with the user information at the step S2104, the operation proceeds to the step S2105 and the list is updated with object operation items which are permitted for the user to execute, and the list of object operation items is returned as a returned value.

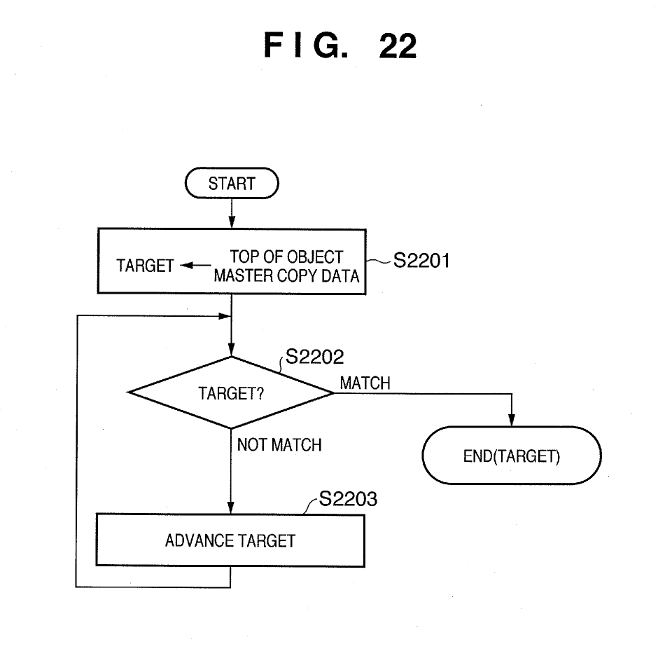

FIG. 22 is a flowchart showing object master copy obtain processing in the first embodiment. First at the step S2201, the target is initialized to the top of the object maser copy data, and the processing after the step S2201 is repeated. Whether the target matches with information on an object master copy described in the object action record data or not is determined at the step S2202. If the target does not match, the operation proceeds to the step S2203 and the target is advanced, and then the operation returns to the step S2202 and the abovementioned processing is repeated. If the target matches with information on the object master copy described in the object action record data at the step S2202, the processing ends with the object master copy data of the target being a returned value.

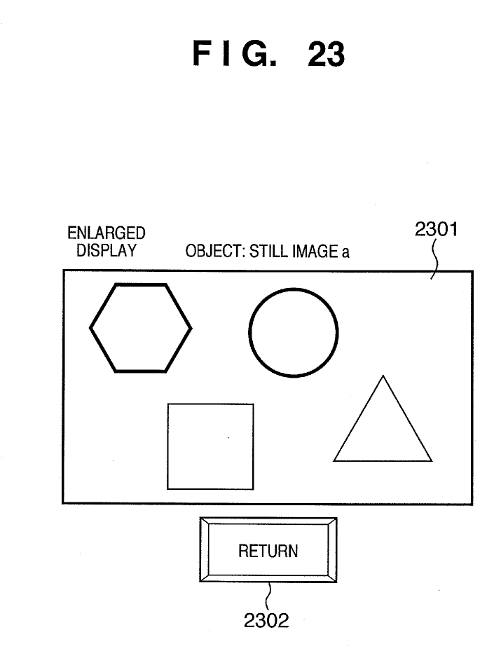

FIG. 23 is a diagram showing an example of an enlarged display presenting screen. The screen is presented after enlarged display is selected at the object operation and the operation is executed. In FIG. 23, the reference numeral 2301 denotes an image which is displayed when a region is cut out from the photographed video data 307 based on an object position shape list of the identified object and subject to the processing such as distortion correction and enlargement. The reference numeral 2302 denotes a “return” button and, when the button is selected, the screen transfers to the conference video operating screen shown in FIG. 10.

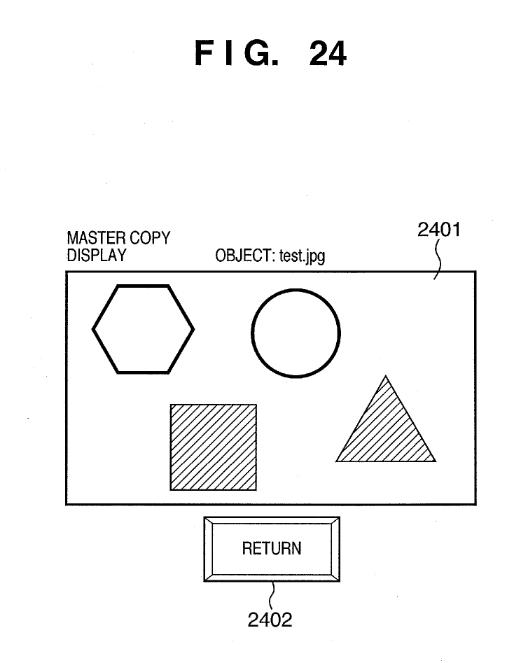

FIG. 24 is a diagram showing an example of a master copy display presenting screen. The screen is presented after master copy display is selected at the object operation and the processing is executed. In FIG. 24, the reference numeral 2401 is object master copy data obtained at the object master copy obtain processing. As the object master copy 2401 is an image clearer than the enlarged object 2301, which is an enlarged region in a conference image, it can present much more detailed information. When “return” button 2402 is selected, the screen transfers to a conference video operating screen shown in FIG. 10.

As such, according to the first embodiment, operation of enlarged display, print, object master copy display, and object master copy print can be executed on an object in a conference screen.

It also can improve security as it enables access controlling of a display object on a display.

It can present only object operation items which can be executed by a user from authority of the display object and information on the operating user as a user interface (UI) in a display object on a display.

### Second Embodiment

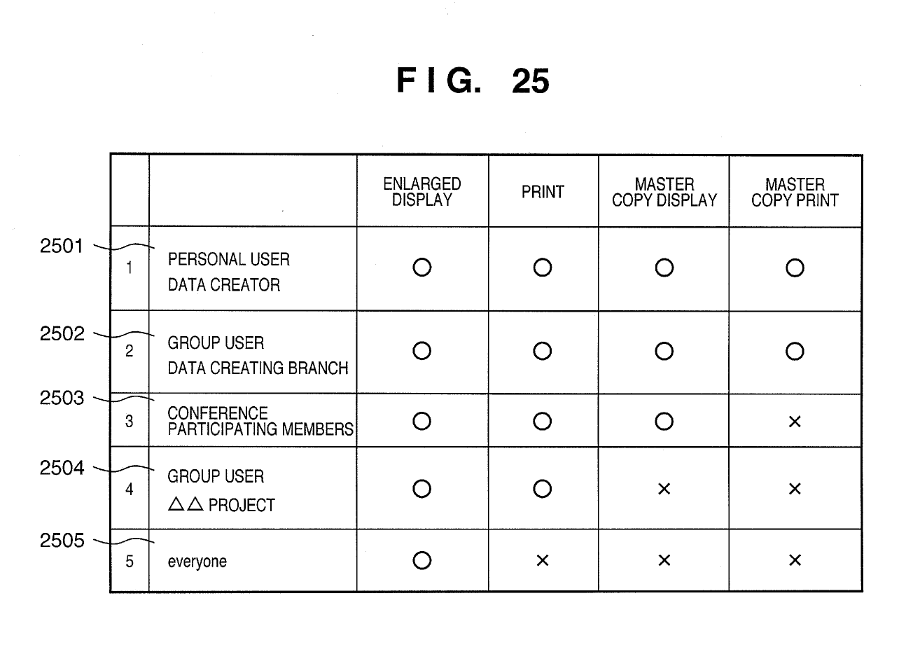

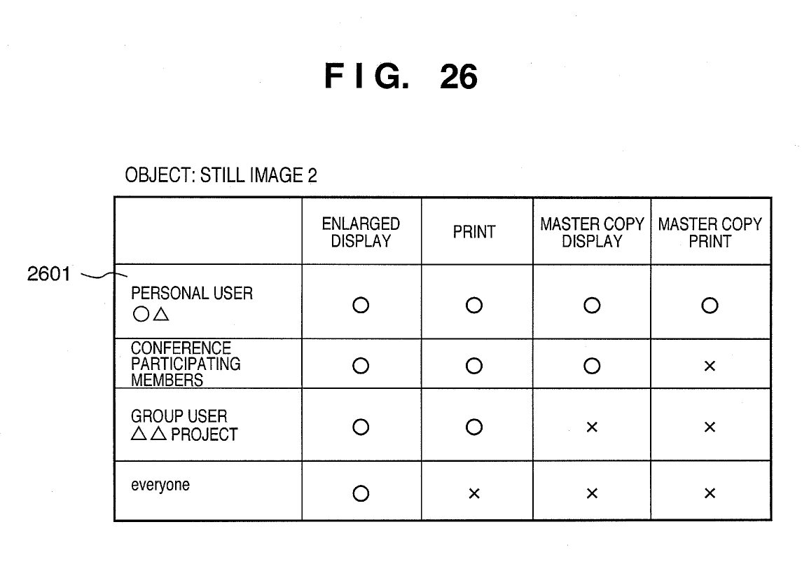

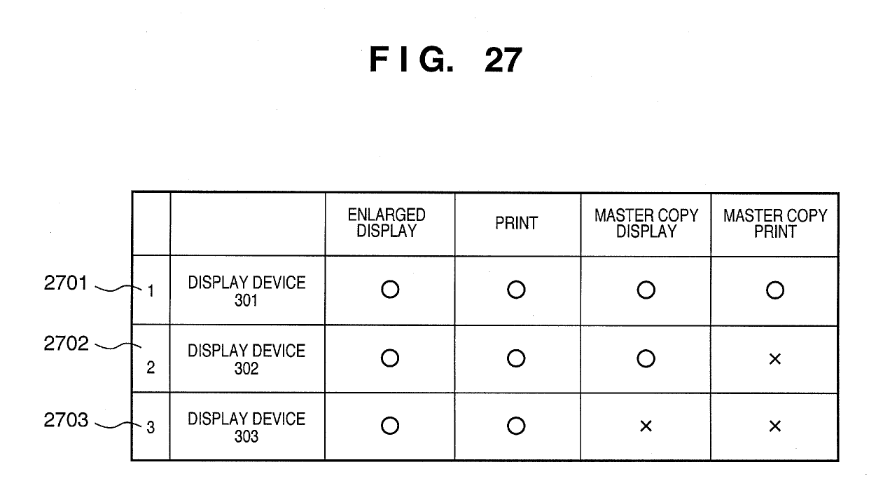

Next, by using FIG. 25 to FIG. 26, a second embodiment according to the present invention will be described in detail. The second embodiment will be described by taking an example of a case where object authority granted to an object can be automatically set based on user information.

FIG. 25 is a diagram showing an example of a template when object authority is automatically set in the second embodiment. By preparing templates as those denoted by the reference numerals 2501 to 2505 shown in FIG. 25 before a conference, it can automatically execute object authority set processing in a conference record according to a template. In the template, a user name can be directly described as “AA project” to a group user name denoted by the reference numeral 2504. Alternatively, a rule to set authority can be described in a template. For example, the name of a user who created an actual object is obtained when object authority is set, such as “data creator” to a personal user denoted by the reference numeral 2501 or “data creating branch” to a group user denoted by the reference numeral 2502, and reflected on the object authority.

Specifically, object authority at when the object authority template is FIG. 25 and a creator of a certain object master copy is “◯Δ” is that denoted by the reference numeral 2601 shown in FIG. 26.

As such, according to the second embodiment, different authority can be set for each object even if the authority is not explicitly set. Particularly, authority setting based on user information can be executed.

### Third Embodiment

Next, by using FIG. 27, a third embodiment according to the present invention will be described in detail. The third embodiment will be described by taking an example of a case where object authority to be granted to an object can be automatically set based on a display device which displays an object.

FIG. 27 is a diagram showing an example of a template when object authority is automatically set in the third embodiment. By preparing templates as those denoted by the reference numerals 2701 to 2703 shown in FIG. 27 before a conference, it can automatically execute object authority set processing in a conference record according to a template. In the template, a display device which displays an object such as “display device 301” is described. In recording a conference, the name of an appliance which actually displays an object is obtained when object authority is set, and reflected on object authority setting. Although the name of an appliance is explicitly described in the third embodiment, coordinate information in an image can be directly described.

As such, according to the third embodiment, different authority can be set for each object even if authority is set explicitly. Particularly, authority setting based on a position of an object or a display appliance can be executed.

### Fourth Embodiment

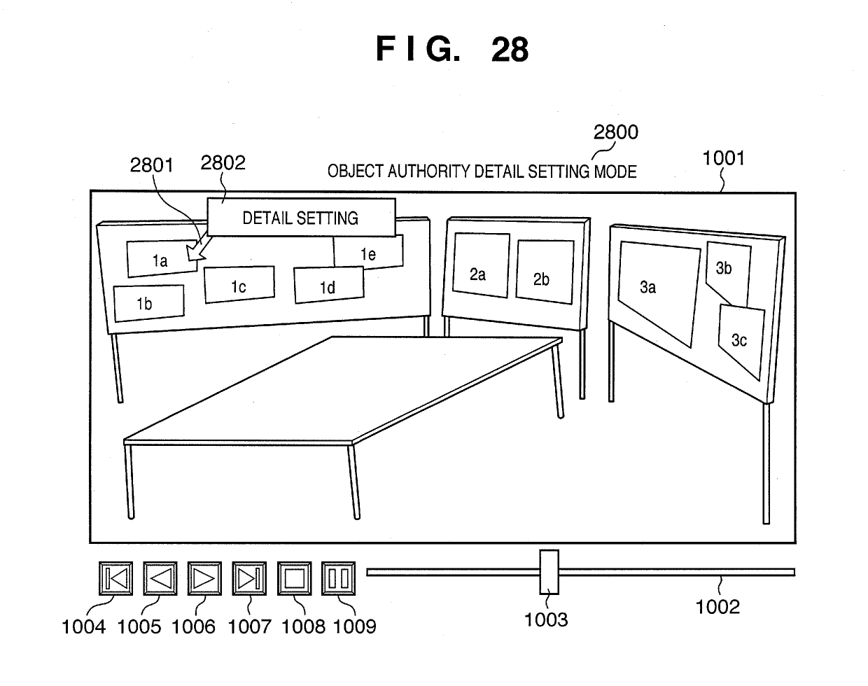

Next, by using FIG. 28 to FIG. 32, a fourth embodiment according to the present invention will be described in detail. The fourth embodiment will be described by taking an example of a case where object authority to be granted to an object can be explicitly designated to be set.

FIG. 28 is a diagram showing an example of a conference video operating screen on which playback operation of a conference video and designation of authority of an object which is displayed on a specified position in the playback video can be executed in the fourth embodiment. As shown in FIG. 28, it shows that it is in an object authority detail setting mode 2800. Only a user who can edit object authority can playback the conference record in the object authority detail setting mode 2800. Here, operation on an object is executed when an arbitrary position in the playback video 1001 is specified 2801 and object authority operation menu 2802 corresponding to the specified position is displayed. When 2802 is selected, the screen transfers to an object authority detail setting screen.

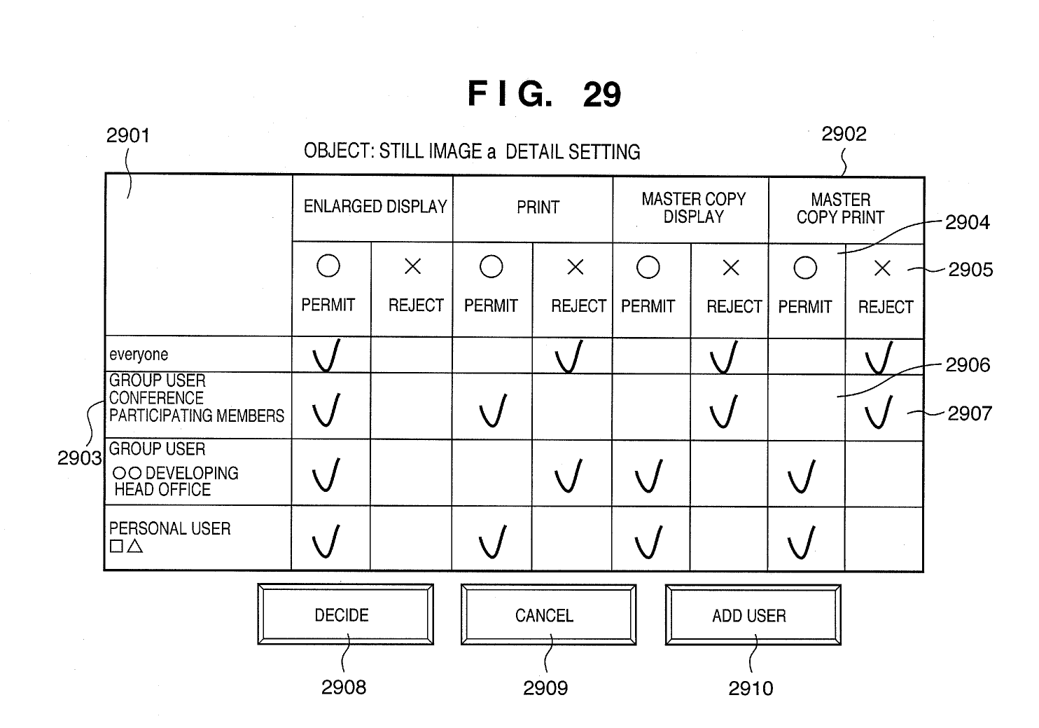

FIG. 29 is a diagram showing an example of an object authority detail setting screen on which object authority of an object can be explicitly set. In FIG. 29, the reference numeral 2901 denotes object authority data. Fields of permit/reject among the cells where the lines of user names cross columns of object operation are checked. For example, the field of reject 2905 among the cells where the group user name “conference participating members” denoted by the reference numeral 2903 cross the object operation “master copy printing” denoted by the reference numeral 2902 is checked 2907. This means that the group user name “conference participating members” are not permitted to operate master copy print.

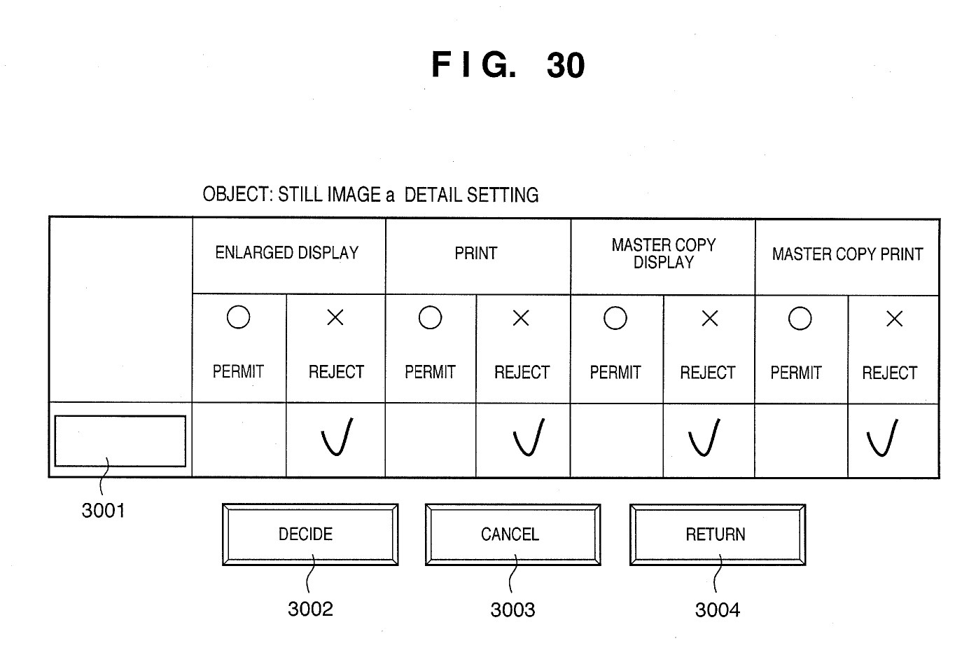

When the field 2906 of permit 2904 is specified, the check mark 2907 moves to the field 2906 of permit 2907, meaning that operation of master copy print is permitted for the group user name “conference participating members”. Decide button 2908, cancel button 2909, and add user adding button 2910 are also present. When the user adding button 2910 is selected, the screen transfers to an object authority detail setting user adding screen (FIG. 30).

FIG. 30 is a diagram showing an example of a user adding screen in object authority detail setting in which object authority of an object can be explicitly set. In a user name inputting field 3001, a user name can be newly inputted and permit/reject can be selected for respective object operation. A decide button 3002, a cancel button 3003, and a return button 3004 are also present. When the return button 3004 is selected, the screen transfers to the object authority detail setting screen shown in FIG. 29.

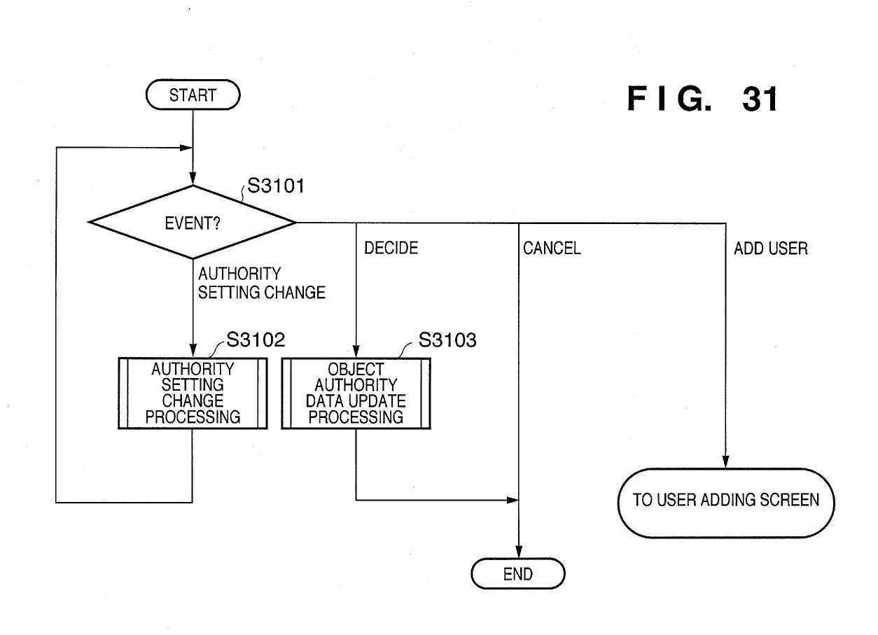

FIG. 31 is a flowchart showing object authority setting designation processing in a fourth embodiment. First at the step S3101, it branches to any of authority setting change for changing the setting of permit/reject of an object operation, decide setting contents, cancel, add user for designating to add a new user according to operation. If the operation is the authority setting change, the operation proceeds to the step S3102, and object authority setting is changed. If the operation is the decide, the operation proceeds to the step S3103, and what performed on the screen shown in FIG. 29 is updated to object authority data and the authority setting ends. If the operation is the add user, the screen transfers to a user adding screen. If the operation is cancel, the processing ends as it is, without updating the authority information.

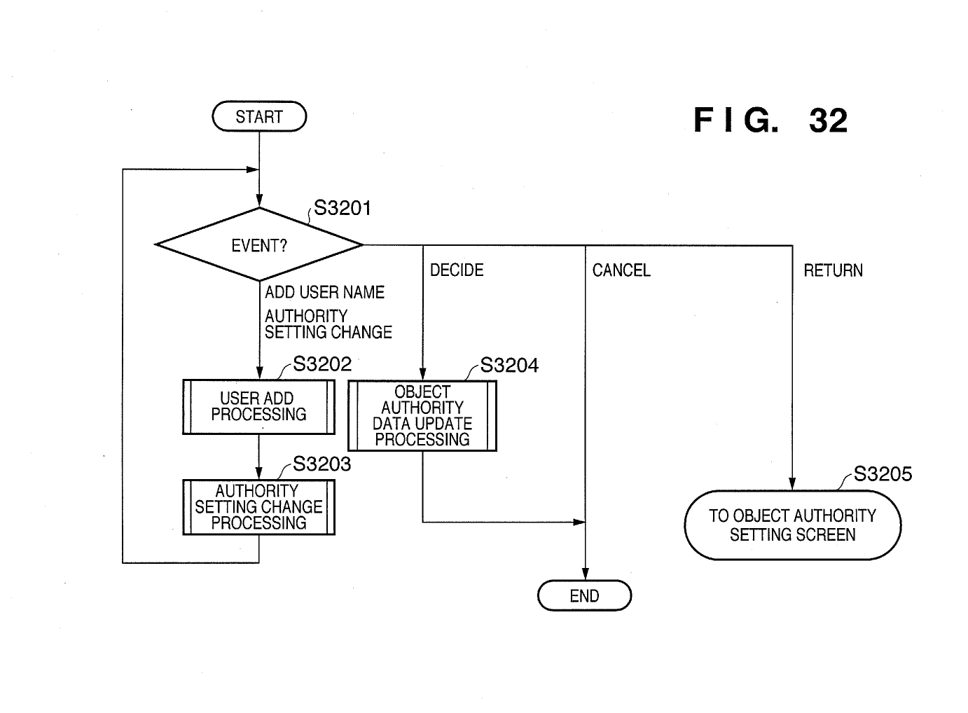

FIG. 32 is a flowchart showing object authority setting user add processing in the fourth embodiment. First at the step S3201, it branches to any of authority setting change for changing the setting of permit/reject of an object operation or add new user name, decide setting contents, cancel, return to an object authority setting screen according to the operation. If the operation is the authority setting change or a new user name addition, the operation proceeds to the step 3202 and the user add processing is executed, and authority setting change processing is executed at the step S3203, and the operation returns to the step S3201 and the abovementioned processing is repeated. If the operation is the decide, the operation proceeds to the step S3204, and what performed on the screen shown in FIG. 30 is updated to object authority data, and the authority set processing ends. If the operation is the return, it returns to the object authority setting screen. If it is the cancel, the processing ends as it is, without updating the authority information.

As such, according to the fourth embodiment, a user can explicitly set and add operation authority of an object.

The present invention may be applied to a system consisting of a plurality of appliances (for example, a host computer, an interface appliance, a reader, a printer and the like), or maybe applied to a device consisting of a single appliance (for example, a copying machine, a facsimile device or the like).

A recording medium that records software program codes for realizing functions of the abovementioned embodiments is supplied to a system or a device, whose computer (a CPU or an MPU) reads and executes the program codes stored in the recording medium. It is needless to say that the objects of the present invention can be achieved by that.

In such a case, program codes read out from the recording medium realizes functions of the abovementioned embodiments, and the recording medium storing the program codes forms the present invention.

As a recording medium for supplying the program codes, a floppy (registered trademark) disk, a hard disk, an optical disk, a magnetic optical disk, CD-ROM, CD-R, a magnetic tape, a non-volatile memory card, ROM or the like can be used.

It is needless to say that not only functions of the abovementioned embodiments are realized when program codes read out by a computer is executed, but also the cases below are included. That is to say, the case where an OS (operating system) or the like running on a computer executes a part or all the actual processing, based on designation of the program codes, and the functions of the abovementioned embodiments are realized by the processing.

Further, the program codes read out from the recording medium write in a function extension board inserted in a computer or memory included in a function extension unit connected to a computer. Then, it is needless to say that, the function extension board or a CPU or the like included in the function extension unit executes a part or all of the actual processing based on designation of the program codes, and the processing realizes the functions of the abovementioned embodiments.

According to the present invention, operation such as enlarged displaying or printing in consideration of security for each object is possible for an appliance or an object of the appliance identified in a playback video.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-240199, filed Aug. 22, 2005, which is hereby incorporated by reference herein in its entirety.

What is claimed is:

1. A video processing apparatus for photographing an action performed to an object with an appliance by a photographing device, recording it as video data, and playing back the video data, comprising:
identifying means for identifying said object specified;
determining means for determining operation authority of a user against said identified object; and
operating means for enabling predetermined operation to be executed against said identified object according to the result of said determination.

2. The apparatus according to claim 1, wherein said predetermined operation includes operation on information corresponding to a master copy of said object.

3. The apparatus according to claim 1, wherein said determining means determines operation authority of said user based on a previously created object authority template.

4. The apparatus according to claim 1, wherein said object authority template defines operation authority against an object based on user information or information for said each object.

5. The apparatus according to claim 1, wherein said object authority template defines a rule for setting operation authority against an object based on user information or information for said each object.

6. The apparatus according to claim 1, further comprising means for designating to explicitly set object authority while said video data is being played back.

7. The apparatus according to claim 1, wherein operation authority against said object is set and a new user who can operate is created against said object.

8. An object processing method of a video processing apparatus which photographs an action performed to an object with an appliance by a photographing device, recording it as video data, and playing back the video data, comprising:
an identifying step of identifying said object specified;
a determining step of determining operation authority of a user against said identified object; and
an operating step of enabling predetermined operation to be executed against said identified object according to the result of said determination.

9. A computer program stored in a computer-readable recording medium for causing a computer to execute the object processing method described in claim 8.

10. A computer-readable recording medium storing a computer program for causing a computer to execute the object processing method described in claim 8.
